(19) United States
(12) Patent Application Publication
(10) Pub. No.: US 2026/0261795 A1
(43) Pub. Date: Sep. 3, 2026

(54) AUDIO OUTPUT DEVICE

(71) Applicant: SONY GROUP CORPORATION, TOKYO (JP)

(72) Inventors: HARUTOSHI YOSHIMURA, TOKYO (JP); KENJI MATSUMOTO, TOKYO (JP); TAKESHI SUZUKI, TOKYO (JP); KENJI YAMADA, TOKYO (JP)

(21) Appl. No.: 18/832,317

(22) PCT Filed: Jan. 24, 2023
(86) PCT No.: PCT/JP2023/002117

§ 371 Date: Jul. 23, 2024

(30) Foreign Application Priority Data
Jan. 31, 2022 (JP) 2022-012800

(51) Int. Cl. H04R 1/30; H04R 1/02

(52) U.S. Cl. CPC H04R 1/30; H04R 1/025; H04R 1/026; H04R 2201/025

(57) ABSTRACT

Disclosed is an audio output device that is formed in a shape having a longitudinal direction, is usable in two different installation states, namely, a vertical installation state and a horizontal installation state, and includes a cabinet, a speaker unit, and a sound conducting duct. The cabinet has an internal acoustic space. The speaker unit is attached to the cabinet and outputs sound. The sound conducting duct has an internal space formed as a sound conducting space to amplify sound outputted from the speaker unit. One end of the sound conducting duct is formed as an audio input port, and the other end is formed as an audio output port. The sound conducting duct is provided with at least two bent sections that are bent in different directions and disposed continuously or separately in a sound conducting direction. In the vertical installation state, the audio input port is positioned above the audio output port. In the horizontal installation state, at least a lower portion of the sound conducting duct is provided as an inclined section that is displaced downward from the audio input port toward the audio output port.

### TECHNICAL FIELD

The present technology relates to a technical field regarding an audio output device that includes a speaker unit for outputting sound and a sound conducting duct for amplifying sound outputted from the speaker unit.

### BACKGROUND ART

Some audio output devices include a speaker unit for outputting sound and a sound conducting duct for amplifying sound outputted from the speaker unit (refer, for example, to PTL 1). The interior space of the sound conducting duct is formed as a sound conducting space. Sound outputted from the speaker unit passes through the sound conducting space, is amplified by the sound conducting duct, and is outputted to the outside from an audio output port of the sound conducting duct.

For an audio output device equipped with a sound conducting duct, an audio output port needs to be formed to open outward from the audio output device in order to ensure a good audio output state. Therefore, in a case where the audio output device is used in a situation where moisture in outdoor or indoor locations is scattered, there is a possibility that the moisture may enter the sound conducting space through the audio output port. If, in such a situation, the moisture enters and flows through the sound conducting space and then reaches the inside of the audio output device through an audio input port, there is a risk of adversely affecting the audio output state of the audio output device.

Accordingly, some audio output devices equipped with a sound conducting duct as described above are configured such that the sound conducting duct suppresses the entry of moisture. For example, the audio output device described in PTL 1 is provided with an upwardly projecting chevron-shaped damming rib that is disposed near the audio output port (horn opening) in the sound conducting duct. The damming rib projects toward the sound conducting space so as to block the moisture entering from the audio output port. The blocked moisture then flows toward the audio output port along the damming rib. This suppresses the entry of moisture in the audio output device.

### CITATION LIST

### Patent Literature

[PTL 1]

Japanese Patent Laid-open No. 2006-237899

### SUMMARY

### Technical Problem

Incidentally, some audio output devices can be used in two states, namely, a vertical installation state and a horizontal installation state, so that a user can use such audio output devices in either of the two different installation states depending, for example, on the usage environment. An audio output device usable in two different installation states is preferably configured to suppress the entry of moisture in the audio output device from the audio output port in any of the different installation states.

Further, if the configuration for suppressing the entry of moisture in the audio output device is complicated, there is a risk of reducing the effect of sound amplification in the sound conducting duct and generating an abnormal sound. Therefore, a simple configuration is preferably adopted to suppress the entry of moisture in the audio output device.

Consequently, the purpose of the audio output device according to the present technology is to ensure a good audio output state by suppressing the entry of moisture in the audio output device with a simple configuration regardless of the installation state in which the audio output device is placed.

### Solution to Problem

Firstly, the audio output device according to the present technology is formed in a shape having a longitudinal direction, is usable in two different installation states, namely, a vertical installation state and a horizontal installation state, and includes a cabinet, a speaker unit, and a sound conducting duct. The cabinet has an internal acoustic space. The speaker unit is attached to the cabinet and outputs sound. The sound conducting duct has an internal space formed as a sound conducting space to amplify sound outputted from the speaker unit. One end of the sound conducting duct is formed as an audio input port, and the other end of the sound conducting duct is formed as an audio output port. The sound conducting duct is provided with at least two bent sections that are bent in different directions and disposed continuously or separately in a sound conducting direction. In the vertical installation state, the audio input port is positioned above the audio output port. In the horizontal installation state, at least a lower portion of the sound conducting duct is provided as an inclined section that is displaced downward from the audio input port toward the audio output port.

As a result, the moisture entering the sound conducting space from the audio output port in the vertical installation state flows downward from an audio input port side to an audio output port side, making it difficult for the moisture to reach the audio input port. Further, the moisture entering the sound conducting space from the audio output port in the horizontal installation state flows downward due to the inclined section, making it difficult for the moisture to reach the audio input port.

Secondly, the above-described audio output device according to the present technology is preferably configured such that the bent sections are formed in a curved shape.

As a result, the bent sections have no angular part.

Thirdly, the above-described audio output device according to the present technology is preferably configured such that at least two of the bent sections are bent in opposite directions.

As a result, two paths bent in opposite directions are formed between the audio input port and the audio output port.

Fourthly, the above-described audio output device according to the present technology is preferably configured such that a first bent section and a second bent section are provided as the bent sections and that, in the sound conducting direction, the first bent section is positioned closer to the audio input port than the second bent section, and further that the first bent section is formed in a projecting curved shape on one side in the axial direction of the audio output port, and still further that the second bent section is formed in a projecting curved shape on the other side in the axial direction of the audio output port.

As a result, the sound conducting space is formed in an S-shape.

Fifthly, the above-described audio output device according to the present technology is preferably configured such that the multiple bent sections are disposed continuously in the sound conducting direction.

As a result, the sound conducting duct shortens to suppress the occurrence of tube resonance in the sound conducting duct.

Sixthly, the above-described audio output device according to the present technology is preferably configured such that, in the horizontal installation state, the center in the up-down direction of the audio output port is positioned below the center in the up-down direction of the speaker unit.

As a result, in the horizontal installation state, the audio input port can easily be positioned above the audio output port.

Seventhly, the above-described audio output device according to the present technology is preferably configured such that, in the vertical installation state, the audio output port is positioned below the speaker unit.

As a result, an amplified sound is outputted from the lower side of the speaker unit.

Eighthly, the above-described audio output device according to the present technology is preferably configured such that a control section for controlling the operation of the speaker unit is disposed above the speaker unit.

As a result, the speaker unit is positioned between the control section and the audio output port as viewed in a longitudinal direction.

Ninthly, the above-described audio output device according to the present technology is preferably configured such that, when a center line in the longitudinal direction is used as a reference line, the audio output port and an operating section for executing a predetermined function are positioned on opposite sides of the reference line in the longitudinal direction.

As a result, the operating section and the sound output port are positioned apart from each other in the longitudinal direction.

Tenthly, the above-described audio output device according to the present technology is preferably configured such that a grabbable handle section is included, and that the audio output port is open in a direction different from the longitudinal direction, and further that at least a part of the handle section is positioned away from and in overlap with the audio output port in a direction perpendicular to the longitudinal direction.

As a result, at least a part of the audio output port is covered by the handle section to grab.

### BRIEF DESCRIPTION OF DRAWINGS

FIG. 1 is a perspective view illustrating an embodiment of an audio output device according to the present technology together with FIGS. 2 to 11.

FIG. 2 is a vertical cross-sectional side view illustrating the audio output device in a vertical installation state.

FIG. 3 is a front view of the audio output device in the vertical installation state.

FIG. 4 is a perspective view of a sound conducting duct.

FIG. 5 is an enlarged vertical cross-sectional view illustrating the sound conducting duct and a handle section in the vertical installation state.

FIG. 6 is a vertical cross-sectional front view of the audio output device in a horizontal installation state.

FIG. 7 is a cross-sectional view illustrating a sound path.

FIG. 8 is a cross-sectional view illustrating a moisture path in the vertical installation state.

FIG. 9 is a cross-sectional view illustrating the moisture path in the horizontal installation state.

FIG. 10 is a cross-sectional view illustrating an example in which an audio output port is placed in a low position in the horizontal installation state.

FIG. 11 is a diagram illustrating an example in which an inclined section is disposed on both the upper and lower sides of the sound conducting duct in the horizontal installation state.

### DESCRIPTION OF EMBODIMENT

An embodiment for implementing an audio output device according to the present technology will now be described with reference to the accompanying drawings.

### Configuration of Audio Output Device

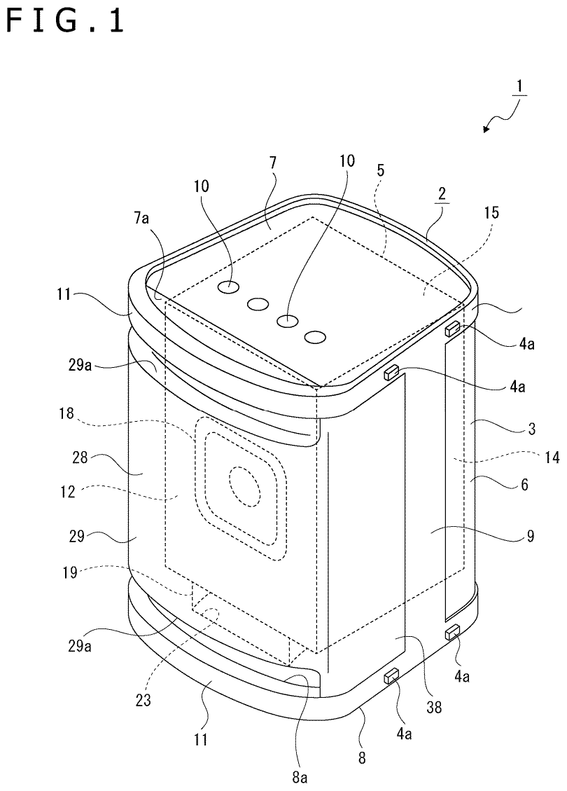

First, a configuration of the audio output device will be described (see FIGS. 1 to 6).

An audio output device 1 is formed in a shape having a longitudinal direction, and can be installed on an undepicted mounting surface, such as the upper surface of a table or a floor, in either a vertical installation state or a horizontal installation state. In the vertical installation state, the audio output device 1 is installed in a vertically long manner. In the horizontal installation state, the audio output device 1 is installed in a horizontally long manner.

A configuration of the audio output device 1 is described below on the assumption that the audio output device 1 is in the vertical installation state, except a part thereof. In the following description, all references to directions, namely, front, back, up, down, left, and right, are made in relation to the audio output device 1 in the vertical installation state. It should be noted that, when the references to the directions are made in relation to the audio output device 1 in the horizontal installation state, they indicate the direction, namely, front, back, up, down, left, or right, in the horizontal installation state. However, the directions indicated below, namely, front, back, up, down, left, and right, are for the convenience of explanation, and the implementation of the present technology is not limited to these directions.

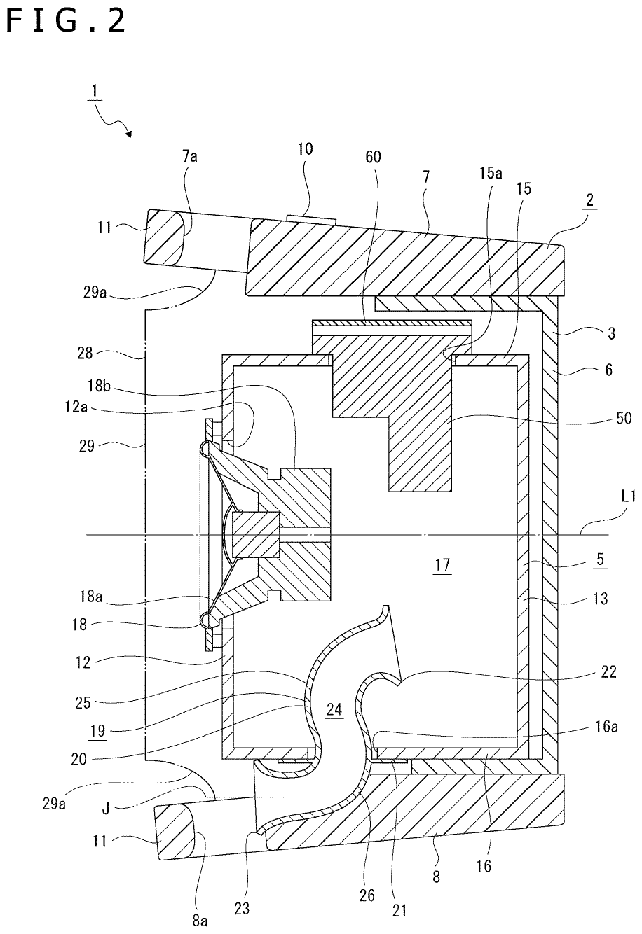

The audio output device 1 includes a vertically elongated housing 2 and various necessary sections supported by or disposed on the housing 2 (see FIGS. 1 and 2). The housing 2 includes a box-shaped outer casing 3, a frame 4 attached to the outer surface of the outer casing 3, and a cabinet 5 disposed inside the outer casing 3.

The outer casing 3 includes a front case section and a rear case section 6. The front case section, which is not depicted, is shaped like a box and is open at the rear. The rear case section 6 is shaped like a box and is open at the front. The front case section and the rear Case section 6 are joined at the front and rear.

The frame 4 includes an upper base section 7, a lower base section 8, and coupling sections 9. The upper base section 7 and the lower base section 8 are vertically spaced apart from each other. The coupling sections 9 couple the upper base section 7 and the lower base section 8 to each other.

The upper base section 7 and the lower base section 8 are each shaped like a plate that is oriented in a substantially up-down direction. Multiple operating sections 10 are disposed on the upper base section 7. The coupling sections 9 are connected to substantially circumferentially opposite portions of the outer circumferences of the upper base section 7 and lower base section 8, respectively. The front ends of the upper base section 7 and lower base section 8 have insertion holes 7a and 8a, respectively. The insertion holes 7a and 8a vertically penetrate the front ends. The upper base section 7 and the lower base section 8 are provided as handle sections 11 that are obtained by forming the outer portions of the insertion holes 7a and 8a, respectively, into a substantially curved shape. The handle section 11 of the lower base section 8 is positioned in front of a later-described audio output port.

The frame 4 is provided with multiple mounting legs 4a. Two of the mounting legs 4a are attached to the outer circumferential surface of the upper base section 7, and the other two mounting legs 4a are attached to the outer circumferential surface of the lower base section 8. The mounting legs 4a are shaped so as to project in the same lateral direction.

The frame 4 is attached to the outer surface of the outer casing 3 in such a manner that the upper surface of the outer casing 3 is covered from above by the upper base section 7 and that the lower surface of the outer casing 3 is covered from below by the lower base section 8. Therefore, when the center line in the longitudinal direction of the housing 2 is L1, the operating sections 10 are positioned above a center line L1.

The audio output device 1 can be carried when fingers are inserted into the insertion holes 7a and 8a in the frame 4 to grab the handle sections 11.

The cabinet 5 is formed in a vertically elongated box shape, and has a front section 12, a rear section 13, side sections 14, a top section 15, and a bottom section 16. The front section 12 and the rear section 13 face in the forward direction and in the rearward direction, respectively. The side sections 14 face in the leftward direction and in the rightward direction, respectively. The top section 15 and the bottom section 16 face in the upward direction and in the downward direction, respectively. The interior of the cabinet 5 is formed as an acoustic space 17.

A first arrangement hole 12a is formed in the front section 12 so as to pass through the front and back of the front section 12. A second arrangement hole 15a is formed in the top section 15 so as to pass through the top and bottom of the top section 15. A third arrangement hole 16a is formed in the bottom section 16 so as to pass through the top and bottom of the bottom section 16.

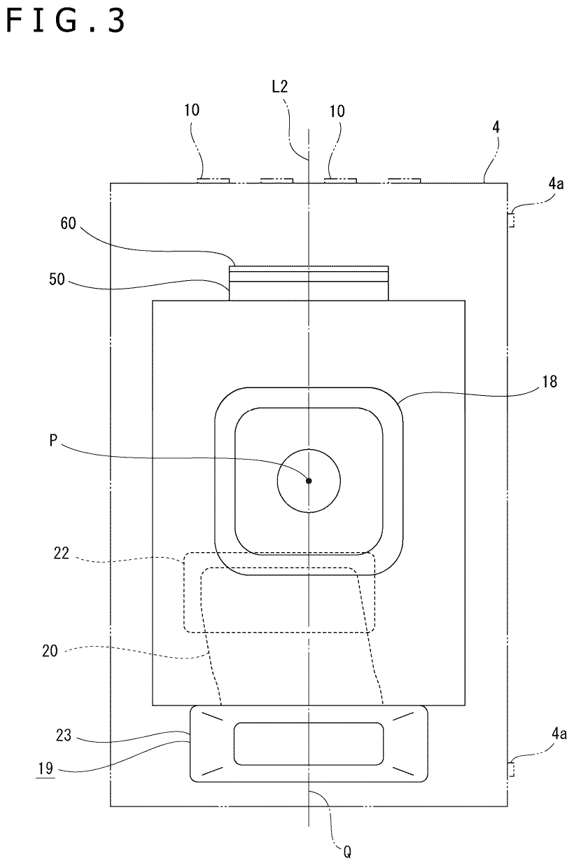

A speaker unit 18 is inserted through the first arrangement hole 12a and disposed in position, and the front end of the speaker unit 18 is attached to the front section 12 of the cabinet 5. The speaker unit 18 is, for example, a dynamic speaker unit, and is attached to the cabinet 5 with a portion of a diaphragm 18a positioned in front of the front section 12. Therefore, the speaker unit 18 is configured such that a magnetic circuit section 18b formed, for example, by a magnet and a yoke, is placed in the acoustic space 17. A center P of the speaker unit 18 is positioned on a center line L2 in the left-right direction of the cabinet 5 (see FIG. 3).

A battery 50 is inserted through the second arrangement hole 15a and disposed in position, and the upper end of the battery 50 is attached to the top section 15 of the cabinet 5 (see FIG. 2). A control circuit board 60 is disposed above the battery 50. Therefore, the control circuit board 60 is disposed above the top section 15. The control circuit board 60 is connected to the battery 50 and the operating sections 10 through an undepicted connection member such as a cable, and functions as a control section that controls the operation of the speaker unit 18.

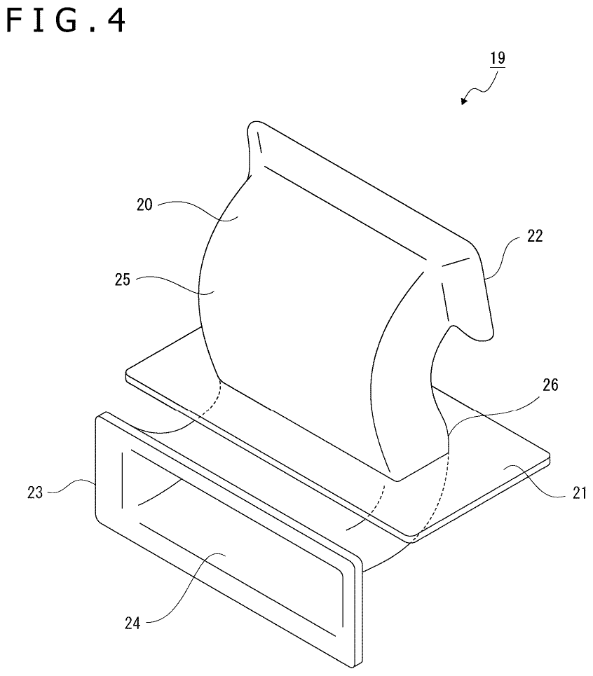

A sound conducting duct 19 is inserted through the third arrangement hole 16a and disposed in position (see FIG. 2). The sound conducting duct 19 is provided, for example, as a bass reflex duct, and has a duct section 20 and a flange section 21. The duct section 20 is formed in a cylindrical shape. The flange section 21 is extended outward from the outer circumference of the duct section 20 (see FIGS. 2 and 4). The sound conducting duct 19 is attached to the cabinet 5 by fastening the flange section 21 with undepicted screws or other fasteners to the bottom section 16 from the lower surface side of the bottom section 16 while the duct section 20 is inserted into the third arrangement hole 168. Therefore, one opening of the duct section 20 is positioned in the acoustic space 17, whereas the other opening is positioned outside the acoustic space 17.

The duct section 20 is configured such that the opening positioned in the acoustic space 17 is formed as an audio input port 22 and that the opening positioned outside the acoustic space 17 is formed as an audio output port 23 (see FIGS. 2 to 4). The audio input port 22 is open mainly to the rear and positioned behind the audio output port 23. The audio output port 23 is open to the front and positioned below the bottom section 16 of the cabinet 5. Therefore, the audio input port 22 is positioned above and behind the audio output port 23. Further, the audio output port 23 is positioned below the center line L1 in the longitudinal direction of the housing 2.

The audio input port 22 and the audio output port 23 are each formed, for example, in a horizontally elongated, substantially rectangular shape (see FIG. 3). The axial direction of the audio output port 23 is in the front-rear direction (see the axis J in FIG. 2).

A center Q in the longitudinal direction (left-right direction) of the audio output port 23 is in alignment with the center line L2 of the cabinet 5 in the left-right direction (see FIG. 3). Therefore, the audio output port 23 is positioned directly below the speaker unit 18.

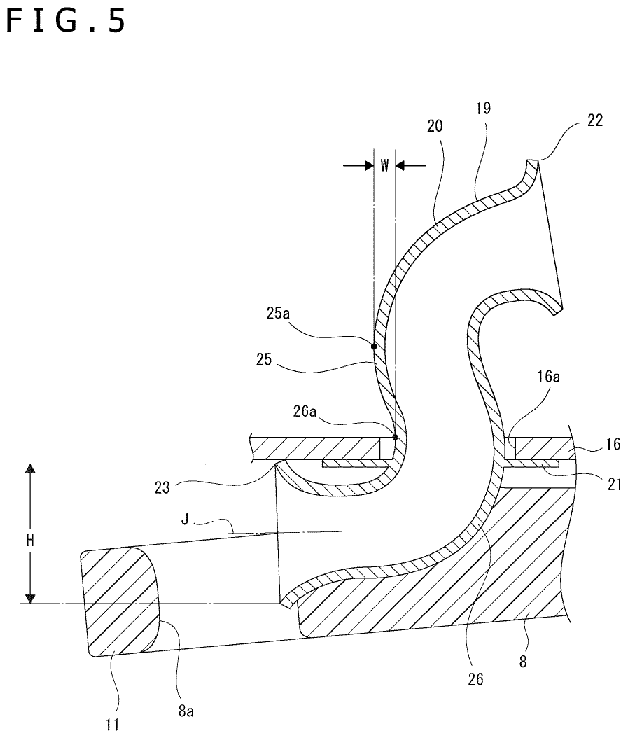

The handle section 11 is positioned in front of the audio output port 23 and separated, in the front-rear direction, from the audio output port 23 (see FIGS. 2 and 5). For example, the upper end portion of the handle section 11 is positioned within a range H between the upper opening edge and the lower opening edge of the audio output port 23 (see FIG. 5). Therefore, a part of the audio output port 23 is positioned in overlap with the handle section 11 in the front-rear direction. It should be noted that the handle section 11 may be entirely positioned within the range H in the up-down direction.

The internal space of the duct section 20 is formed as a sound conducting space 24. Sound inputted from the audio input port 22 to the sound conducting space 24 is transmitted through the sound conducting space 24 and outputted from the audio output port 23. Therefore, the direction from the audio input port 22 to the audio output port 23 is a sound conducting direction in which the sound is transmitted in the sound conducting duct 19.

The duct section 20 is shaped in such a manner that both of the ends in the sound conducting direction become displaced outward as they approach the audio input port 22 and the audio output port 23, respectively. The sound conducting space 24 is formed such that a portion other than both of the ends in the sound conducting direction makes the area of the cross-section in the sound conducting direction constant.

The duct section 20 has a first bent section 25 and a second bent section 26. The first bent section 25 and the second bent section 26 are bent in opposite directions. In the sound conducting direction, the first bent section 25 and the second bent section 26 are disposed, for example, continuously while the first bent section 25 is positioned toward the audio input port 22 and the second bent section 26 is positioned toward the audio output port 23. Therefore, the first bent section 25 is positioned above the second bent section 26.

The first bent section 25 is bent forward in a projecting curved shape, and the second bent section 26 is bent rearward in a projecting curved shape. When a section positioned furthest forward on the front surface of the first bent section 25 is referred to as a first section 25a while a section positioned furthest rearward on the front surface of the second bent section 26 is referred to as a second section 26a, the first section 25a of the duct section 20 is positioned ahead of the second section 26a by a width W depicted in FIG. 5. Therefore, the duct section 20 has an S-shaped cross-section along the sound conducting direction.

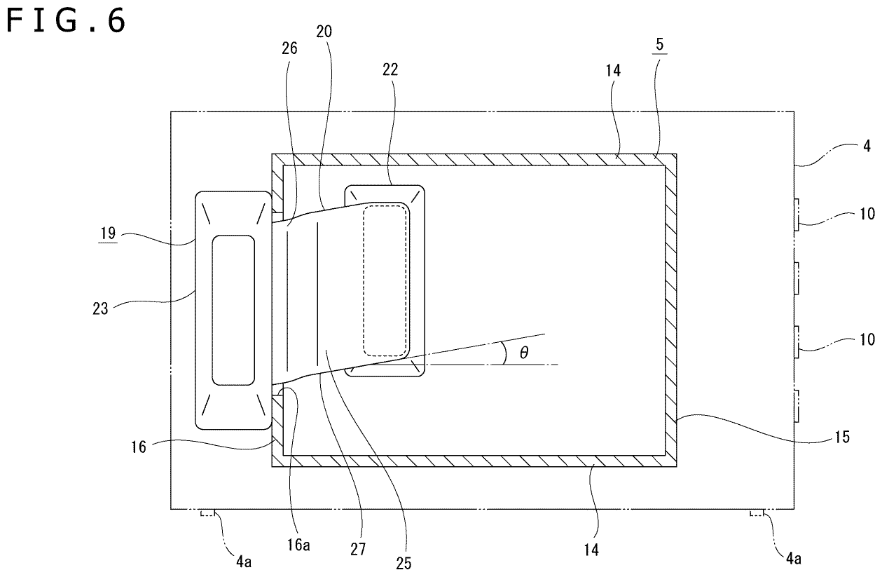

The duct section 20 has an inclined shape that is displaced downward as a whole from the audio input port 22 to the audio output port 23 in the horizontal installation state. The lower portion of the duct section 20 in the horizontal installation state is provided as an inclined section 27 (see FIG. 6). Therefore, even in the horizontal installation state, the audio input port 22 is positioned above the audio output port 23, as is the case with the vertical installation state. The inclined section 27 has an inclination angle θ of, for example, 10 degrees or more with respect to the horizontal plane. It should be noted that the duct section 20 is only required to be inclined in the horizontal installation state so as to displace at least the inclined section 27 downward from the audio input port 22 to the audio output port 23.

A grille cover 28 is attached to the outer casing 3 from the front side (see FIGS. 1 and 2). The grille cover 28 has a front section 29, side sections 30, and cutouts 29a. The cutouts 29a are formed on the top and bottom of the front section 29 and open upward or downward. The grille cover 28 is inserted from the front into a space surrounded by the upper base section 7, lower base section 8, and coupling sections 9 of the frame 4, and is attached to the outer surface of the outer casing 3. Therefore, the grille cover 28 covers the cabinet 5 from the front and the sides.

The cutouts 29a in the grille cover 28 form a space below the upper base section 7 and a space above the lower base section 8 into which the fingers of a user can be inserted. Therefore, the user can easily grab the handle sections 11 by inserting his/her fingers into the spaces formed by the insertion holes 7a and 8a in the frame 4 and the cutouts 29a.

As described above, the audio output device 1 can be placed on a mounting surface in either the vertical installation state or the horizontal installation state (see FIGS. 1, 2, and 6). The vertical installation state is a state where the audio output device 1 is installed in a vertically long state. The horizontal installation state is a state where the audio output device 1 is installed in a horizontally long state.

The user recognizes the direction in which the operating sections 10 disposed on the upper base section 7 are oriented upward, and places the audio output device 1 on the mounting surface in the vertical installation state (see FIGS. 1 and 2). Further, the user recognizes the direction in which the mounting legs 4a of the frame 4 are positioned in contact with the mounting surface, and places the audio output device 1 on the mounting surface in the horizontal installation state (see FIG. 6).

In the audio output device 1 configured as described above, the control circuit board 60, which functions as a control section in the vertical installation state, is disposed above the cabinet 5, and the audio output port 23 is positioned below the cabinet 5. As a result, in the longitudinal direction of the cabinet 5, the speaker unit 18 is positioned between the control circuit board 60 and the audio output port 23. Consequently, various sections are arranged in the longitudinal direction with respect to the cabinet 5. This makes it possible to downsize the cabinet 5 in a direction perpendicular to the longitudinal direction.

### Sound Path Etc.

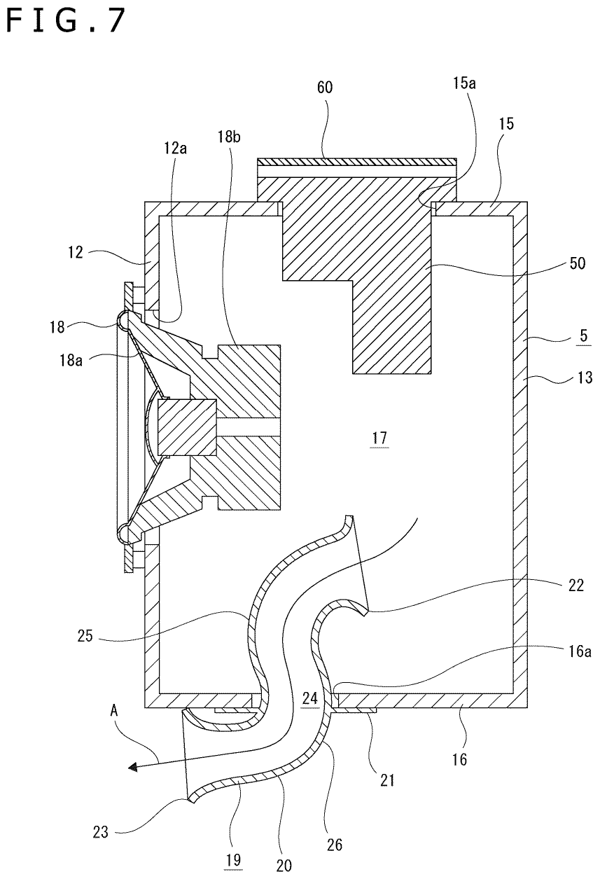

The following description relates to a sound path etc. in the sound conducting duct 19 (see FIG. 7).

Sound outputted from the speaker unit 18 to the acoustic space 17 passes through the sound conducting space 24 from the audio input port 22 of the sound conducting duct 19, and is outputted to the outside from the audio output port 23 (see the arrow A in FIG. 7).

In the above instance, the first bent section 25 and the second bent section 26 of the sound conducting duct 19 are formed in a curved shape, so that the sound conducting duct 19 has no angular part. Therefore, the shapes of the first bent section 25 and the second bent section 26 do not adversely affect the sound outputted from the speaker unit 18. This ensures a good audio output state in the audio output device 1.

Further, the first bent section 25 and the second bent section 26 are disposed continuously in the sound conducting direction. Consequently, the length of the sound conducting duct 19 in the sound conducting direction is reduced to suppress the occurrence of tube resonance in the sound conducting duct 19. This makes it possible to suppress the deterioration of sound quality of sound outputted from the speaker unit 18 within the sound conducting space 24. Furthermore, reducing the length of the sound conducting duct 19 in the sound conducting direction results in downsizing the audio output device 1.

Moreover, the audio output device 1 placed in the vertical installation state is configured such that the center P of the speaker unit 18 and the center Q in the left-right direction of the audio output port 23 are positioned on the center line 12 of the left-right direction of the cabinet 5 and that the audio output port 23 is positioned below the speaker unit 18. Therefore, sound amplified by the sound conducting duct 19 is outputted from the lower side of the speaker unit 18. Consequently, the sound amplified by the sound conducting duct 19 is outputted from the vicinity of the mounting surface by the speaker unit 18 so as to obtain a high sound amplification effect due to the sound conducting duct 19. Additionally, the audio output port 23 is positioned below the speaker unit 18 and is thus inconspicuous and difficult to be visually recognized. This makes it possible to improve the design of the audio output device 1.

### Moisture Path etc.

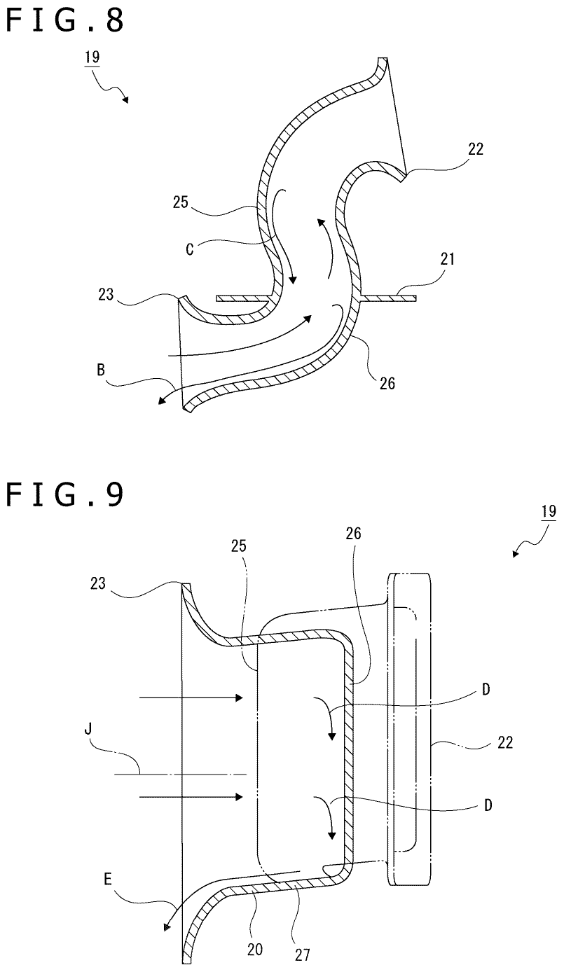

The following description relates to a moisture path etc. in a case where moisture has entered the sound conducting duct 19 (see FIGS. 8 and 9).

In a case where the audio output device 1 is used in a situation where outdoor or indoor moisture is scattered, there is a possibility that the moisture may enter the sound conducting space 24 from the audio output port 23.

The flow strength of the moisture entering the sound conducting space 24 from the audio output port 23 in the vertical installation state is diminished by the second bent section 26, flows downward, and flows out of the audio output device 1 from the audio output port 23 (see the arrow B in FIG. 7). In a case where the flow strength of the moisture entering from the audio output port 23 is high, or depending on the angle at which the moisture enters, the moisture may splash in the second bent section 26 and reach the first bent section 25. However, the flow strength of the moisture reaching the first bent section 25 is diminished by the first bent section 25 and flows downward (see the arrow C in FIG. 7). The moisture flowing downward from the first bent section 25 flows out of the audio output device 1 from the audio output port 23 through the second bent section 26.

The flow strength of the moisture entering the sound conducting space 24 from the audio output port 23 in the horizontal installation state is diminished by the second bent section 26, and flows downward (see the arrows D in FIG. 7). Here, as described earlier, the lower portion of the sound conducting duct 19 is provided as the inclined section 27 that is inclined so as to be displaced downward from the audio input port 22 toward the audio output port 23. Therefore, the moisture flowing downward in the second bent section 26 flows to the inclined section 27, flows to the audio output port 23 due to the inclined section 27, and flows out of the audio output device 1 from the audio output port 23 (see the arrow E in FIG. 7).

Further, as is the case with the vertical installation state, the moisture splashing in the second bent section 26 may reach the first bent section 25 depending on the flow strength and angle of the entering moisture. However, the flow strength of the moisture reaching the first bent section 25 is diminished by the first bent section 25, flows downward, flows to the audio output port 23 due to the inclined section 27, and flows out of the audio output device 1 from the audio output port 23.

As described above, the sound conducting duct 19 is configured such that the first bent section 25 and the second bent section 26 are bent in opposite directions. Therefore, two paths bent in opposite directions are formed in the sound conducting direction from the audio input port 22 to the audio output port 23. Consequently, the shape of the sound conducting duct 19 significantly impedes the flow of moisture from the audio output port 23 to the audio input port 22. This makes it possible to sufficiently suppress the entry of moisture in the sound conducting space 24.

As described above, when the audio output device 1 is in the vertical installation state, the moisture entering the sound conducting space 24 from the audio output port 23 flows downward from the audio input port 22 to the audio output port 23 due to the first bent section 25 and the second bent section 26. This makes it difficult for the moisture to reach the audio input port 22. Further, the flow strength of the moisture entering the sound conducting space 24 from the audio output port 23 in the horizontal installation state is diminished by the first bent section 25 and the second bent section 26, flows downward, and flows downward along the inclined section 27 disposed below the sound conducting duct 19. This makes it difficult for the moisture to reach the audio input port 22.

Therefore, the entry of moisture in the acoustic space 17 from the sound conducting duct 19 can be suppressed with a simple configuration regardless of the installation state in which the audio output device 1 is placed. This makes it possible to ensure a good audio output state.

Further, the first bent section 25 and the second bent section 26 are formed in a curved shape, and have no angular part. Therefore, it is difficult for the moisture entering from the audio output port 23 to smoothly flow or stay in the sound conducting space 24. This ensures that the moisture entering the sound conducting space 24 can flow out from the audio output port 23.

Further, the sound conducting duct 19 is configured such that the first bent section 25 is positioned closer to the audio input port 22 than the second bent section 26 in the sound conducting direction and that the axial direction of the audio output port 23 is in the front-rear direction, and further that the first bent section 25 is bent forward in a projecting curved shape, and still further that the second bent section 26 is bent rearward in a projecting curved shape. As a result, the sound conducting space 24 has an S-shaped cross-section along the sound conducting direction.

Consequently, the moisture entering the sound conducting space 24 from the audio output port 23 due to the first bent section 25 and the second bent section 26 is made less likely to flow toward the audio input port 33 without excessively complicating the shape of the sound conducting space 24. Therefore, it is possible to avoid an adverse effect on the audio output from the sound conducting duct 19 and further suppress the entry of moisture in the sound conducting space 24 from the audio output port 23.

Further, in the audio output device 1, the operating sections 10 and the audio output port 23 are disposed on opposite sides of the center line L2 in the longitudinal direction of the housing 2. Consequently, the operating sections 10 and the audio output port 23 are positioned apart from each other in the longitudinal direction. Therefore, the hands of the user operating the operating sections 10 are less likely to come into contact with the audio output port 23. As a result, even in a case where the operating sections 10 are operated with wet hands, the entry of moisture into the audio output port 23 from the hands is suppressed. This suppresses the entry of moisture in the sound conducting space 24.

Furthermore, the handle section 11 of the housing 2 is disposed in front of the audio output port 23, and at least a part of the handle section 11 is positioned away from and in overlap with the audio output port 23 in the front-rear direction. Therefore, at least a part of the audio output port 23 is covered by the handle section 11, which is grabbed to carry the audio output device 1.

Consequently, in a situation where moisture is scattered, the handle section 11 blocks the moisture from flowing toward the audio output port 23. This makes it possible to suppress the entry of moisture into the sound conducting space 24 from the audio output port 23. Further, the audio output port 23 is hidden and made inconspicuous by the handle section 11. This can improve the design quality of the audio output device 1.

It should be that the sound conducting duct 19 may be provided with three or more bent sections although the sound conducting duct 19 provided with two bent sections, namely, the first bent section 25 and the second bent section 26, is depicted in the illustrated example. When the sound conducting duct 19 is provided with three or more bent sections, it becomes more difficult for the moisture entering the sound conducting space 24 from the audio output port 23 to reach the audio input port 22.

Further, the first bent section 25 and the second bent section 26 may be disposed apart from each other in the sound conducting direction, and may be bent in directions other than the opposite directions as long as they are bent in different directions. Furthermore, the cross-section of the sound conducting duct 19 along the sound conducting direction may be formed in a shape other than an S-shape as long as the shape makes it difficult for the moisture entering the sound conducting space 24 from the audio output port 23 to reach the audio input port 22.

### Others

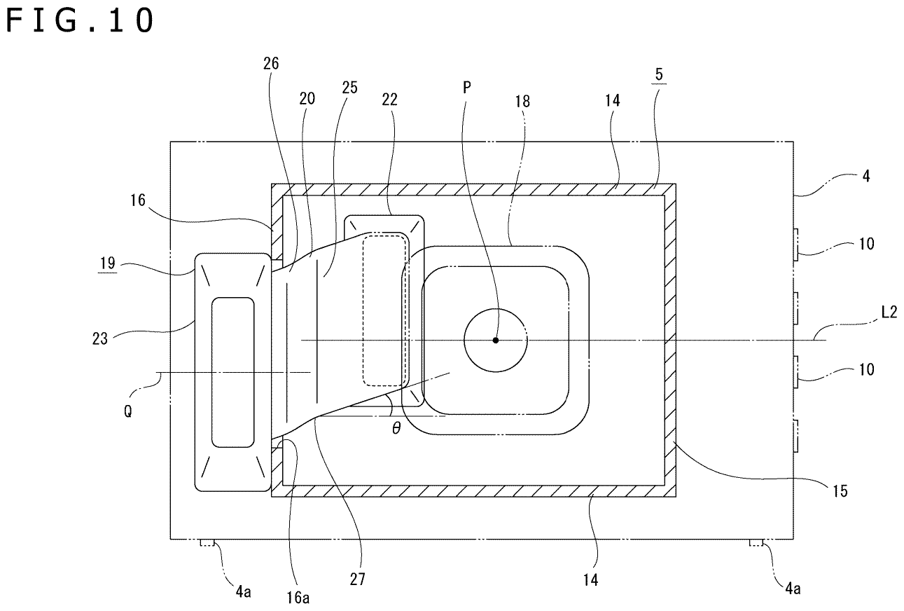

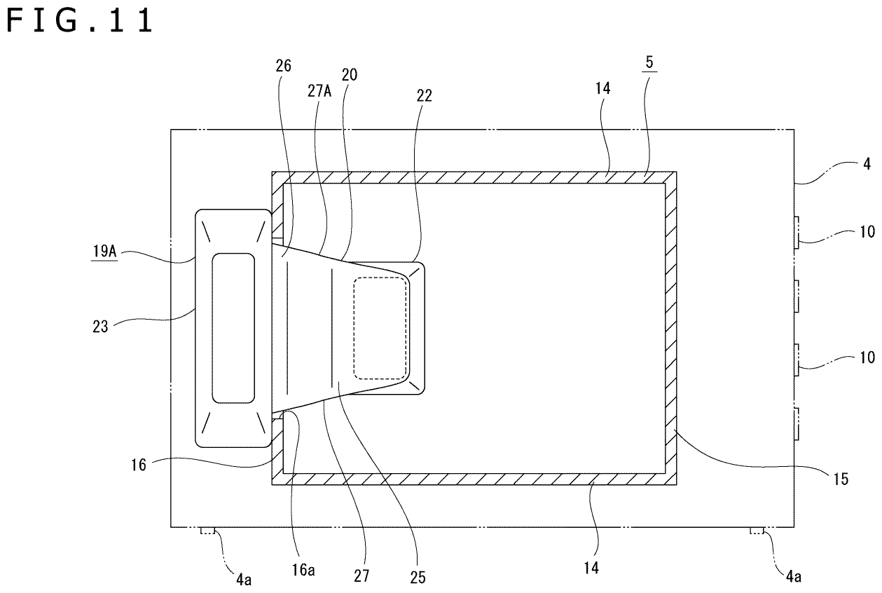

The above-illustrated example indicates that the center Q in the longitudinal direction (left-right direction) of the audio output port 23 in the vertical installation state is positioned directly below the center P of the speaker unit 18, that is, in the horizontal installation state, the center Q in the longitudinal direction (up-down direction) of the audio output port 23 and the center P of the speaker unit 18 are flush with each other in the up-down direction (see FIG. 3). However, in the horizontal installation state, the center Q of the audio output port 23 may be positioned below the center P of the speaker unit 18 (see FIG. 10). This makes it easier to position the audio input port 22 above the audio output port 23 in the horizontal installation state. As a result, the inclination angle e of the inclined section 27 can be increased to ensure that the moisture entering the sound conducting space 24 flows toward the audio output port 23.

Further, the above-illustrated example indicates that at least the lower portion of the sound conducting duct 19 is provided as the inclined section 27, which is inclined so as to be displaced downward from the audio input port 22 to the audio output port 23 in the horizontal installation state. However, a sound conducting duct 19A may be used instead of the sound conducting duct 19. The sound conducting duct 19A is formed in such a manner that its upper and lower portions are formed separately from each other along the sound conducting direction in the horizontal installation state (see FIG. 11).

In the horizontal installation state, the lower portion of the sound conducting duct 19A is provided as the inclined section 27, which is displaced downward from the audio input port 22 to the audio output port 23, and the upper portion of the sound conducting duct 19A is provided as an inclined section 27A that is displaced upward from the audio input port 22 toward the audio output port 23. As a result, in a case, for example, where the audio output device 1 is erroneously placed in a wrong orientation by the user and is used in the horizontal installation state with the mounting legs 4a facing upward, the moisture entering the sound conducting space 24 from the audio output port 23 flows out along the inclined section 27A because the inclined section 27A is placed in a state where it is displaced downward from the audio input port 22 toward the audio output port 23. Therefore, regardless of the orientation of the audio output device 1 in the horizontal installation state, the moisture entering the sound conducting space 24 can be made to flow toward the audio output port 23.

It should be noted that, in the sound conducting duct 19A, the sound conducting space 24 is preferably formed in a shape having a constant cross-sectional area in the sound conducting direction. When, for example, two sections for coupling the inclined section 27 to the inclined section 27A are referred to as the coupling sections, the sound conducting duct 19A is shaped in such a manner that the two coupling sections separate from each other in the sound conducting direction when they approach from the audio output port 23 toward the audio input port 22.

### Present Technology

The present technology can be configured as follows.

(1)

An audio output device formed in a shape having a longitudinal direction and usable in two different installation states, namely, a vertical installation state and a horizontal installation state, the audio output device including:
a cabinet that has an internal acoustic space;
a speaker unit that is attached to the cabinet and outputs sound; and
a sound conducting duct that has an internal space formed as a sound conducting space to amplify sound outputted from the speaker unit, in which
one end of the sound conducting duct is formed as an audio input port, and the other end of the sound conducting duct is formed as an audio output port,
the sound conducting duct is provided with at least two bent sections that are bent in different directions and disposed continuously or separately in a sound conducting direction,
in the vertical installation state, the audio input port is positioned above the audio output port, and,
in the horizontal installation state, at least a lower portion of the sound conducting duct is provided as an inclined section that is displaced downward from the audio input port toward the audio output port.
   (2)

The audio output device according to (1) above, in which
the bent sections are formed in a curved shape.
   (3)

The audio output device according to (1) or (2) above, in which
at least two of the bent sections are bent in opposite directions.
   (4)

The audio output device according to any one of (1) to (3) above, in which
a first bent section and a second bent section are provided as the bent sections,
in the sound conducting direction, the first bent section is positioned closer to the audio input port than the second bent section,
the first bent section is formed in a projecting curved shape on one side in an axial direction of the audio output port, and
the second bent section is formed in a projecting curved shape on the other side in the axial direction of the audio output port.
   (5)

The audio output device according to (1) or (4) above, in which
the multiple bent sections are disposed continuously in the sound conducting direction.
   (6)

The audio output device according to any one of (1) to (5) above, in which,
in the horizontal installation state, a center in an up-down direction of the audio output port is positioned below a center in the up-down direction of the speaker unit.
   (7)

The audio output device according to any one of (1) to (6) above, in which,
in the vertical installation state, the audio output port is positioned below the speaker unit.
   (8)

The audio output device according to any one of (1) to (7) above, in which
a control section for controlling operation of the speaker unit is disposed above the speaker unit.
   (9)

The audio output device according to any one of (1) to (8) above, in which,
when a center line in the longitudinal direction is used as a reference line, the audio output port and an operating section for executing a predetermined function are positioned on opposite sides of the reference line in the longitudinal direction.
   (10)

The audio output device according to any one of (1) to (9) above, in which
a grabbable handle section is included,
the audio output port is open in a direction different from the longitudinal direction, and
at least a part of the handle section is positioned away from and in overlap with the audio output port in a direction perpendicular to the longitudinal direction.

### REFERENCE SIGNS LIST

1: Audio output device
5: Cabinet
11: Handle section
17: Acoustic space
18: Speaker unit
19: Sound conducting duct
22: Audio input port
23: Audio output port
24: Sound conducting space
25: First bent section
26: Second bent section
27: Inclined section
J: Axis
L1: Center line
L2: Center line
P: Center
Q: Center

1. An audio output device formed in a shape having a longitudinal direction and usable in two different installation states, namely, a vertical installation state and a horizontal installation state, the audio output device comprising:
a cabinet that has an internal acoustic space;
a speaker unit that is attached to the cabinet and outputs sound; and
a sound conducting duct that has an internal space formed as a sound conducting space to amplify sound outputted from the speaker unit, wherein
one end of the sound conducting duct is formed as an audio input port, and the other end of the sound conducting duct is formed as an audio output port,
the sound conducting duct is provided with at least two bent sections that are bent in different directions and disposed continuously or separately in a sound conducting direction,
in the vertical installation state, the audio input port is positioned above the audio output port, and,
in the horizontal installation state, at least a lower portion of the sound conducting duct is provided as an inclined section that is displaced downward from the audio input port toward the audio output port.

2. The audio output device according to claim 1, wherein
the bent sections are formed in a curved shape.

3. The audio output device according to claim 1, wherein
at least two of the bent sections are bent in opposite directions.

4. The audio output device according to claim 3, wherein
a first bent section and a second bent section are provided as the bent sections,
in the sound conducting direction, the first bent section is positioned closer to the audio input port than the second bent section,
the first bent section is formed in a projecting curved shape on one side in an axial direction of the audio output port, and
the second bent section is formed in a projecting curved shape on the other side in the axial direction of the audio output port.

5. The audio output device according to claim 1, wherein
the multiple bent sections are disposed continuously in the sound conducting direction.

6. The audio output device according to claim 1, wherein,
in the horizontal installation state, a center in an up-down direction of the audio output port is positioned below a center in the up-down direction of the speaker unit.

7. The audio output device according to claim 1, wherein,
in the vertical installation state, the audio output port is positioned below the speaker unit.

8. The audio output device according to claim 7, wherein
a control section for controlling operation of the speaker unit is disposed above the speaker unit.

9. The audio output device according to claim 1, wherein,
when a center line in the longitudinal direction is used as a reference line, the audio output port and an operating section for executing a predetermined function are positioned on opposite sides of the reference line in the longitudinal direction.

10. The audio output device according to claim 1, wherein
a grabbable handle section is included,
the audio output port is open in a direction different from the longitudinal direction, and
at least a part of the handle section is positioned away from and in overlap with the audio output port in a direction perpendicular to the longitudinal direction.
